(19) United States
(12) Patent Application Publication
(10) Pub. No.: US 2022/0135489 A1
(43) Pub. Date: May 5, 2022

(54) METHOD FOR PREPARING CONTINUOUS FIBER-REINFORCED CERAMIC MATRIX COMPOSITE BY FLASH SINTERING TECHNOLOGY

(71) Applicant: SHANGHAI JIAO TONG UNIVERSITY, Shanghai (CN)

(72) Inventors: Juan Jiang, Shanghai (CN); Na Ni, Shanghai (CN); Xiaofeng Zhao, Shanghai (CN); Qi Ding, Shanghai (CN); Weiwei Xiao, Shanghai (CN); Yinchun Shi, Shanghai (CN)

(73) Assignee: SHANGHAI JIAO TONG UNIVERSITY, Shanghai (CN)

(21) Appl. No.: 17/509,716

(22) Filed: Oct. 25, 2021

(30) Foreign Application Priority Data
Oct. 29, 2020 (CN) 202011176983.6

(51) Int. Cl. C04B 35/64; C04B 35/48; C04B 35/10; C04B 35/565; C04B 35/76

(52) U.S. Cl. CPC C04B 35/64; C04B 35/48; C04B 35/10; C04B 35/565; C04B 35/76; C04B 2235/5445; C04B 2235/5236; C04B 2235/5244; C04B 2235/96; C04B 2235/602; C04B 2235/5454; C04B 2235/5224

(57) ABSTRACT

The present disclosure discloses a method for preparing a continuous fiber-reinforced ceramic matrix composite by flash sintering technology, including: placing a continuous ceramic fiber preform in a mold, adding a nano-ceramic powder, and subjecting the resultant to mechanical oscillation and press forming in sequence to obtain a green body; heating the green body to a preset temperature and applying an electric field with a preset electric field intensity, until occurrence of flash sintering; and converting a power supply from a constant voltage state to a constant current state, holding at the temperature and cooling to obtain the continuous fiber-reinforced ceramic matrix composite.

### CROSS REFERENCE TO RELATED APPLICATION

This patent application claims the benefit and priority of Chinese Patent Application No. 202011176983.6 filed on Oct. 29, 2020, the disclosure of which is incorporated by reference herein in its entirety as part of the present application.

### TECHNICAL FIELD

The present disclosure belongs to the technical field of continuous fiber-reinforced ceramic matrix composites, and relates to a method for preparing a continuous fiber-reinforced ceramic matrix composite by flash sintering technology.

### BACKGROUND ART

Continuous fiber-reinforced ceramic matrix composite is a high performance composite formed by placing a continuous ceramic fiber into a ceramic matrix. The continuous fiber-reinforced ceramic matrix composite not only has the advantages of the ceramic matrix, such as high temperature resistance, oxidation resistance, creep resistance, high strength and corrosion resistance, but also can overcome the shortcomings of low fracture toughness and poor impact resistance of a bulk-structure ceramic. The pseudoplastic fracture mode of the continuous fiber-reinforce ceramic matrix composite can avoid catastrophic problems caused by the brittle fracture of structural parts during use. The continuous fiber-reinforced ceramic matrix composite, as a high temperature thermal structure material with excellent comprehensive property, has an extensive application prospect in the fields of aviation, aerospace and nuclear energy (Rebecca Gottlieb, Shannon Poges, Chris Monteleone, Steven L Suib, Continuous fiber-reinforced ceramic matrix composites, In book: Advanced Ceramic Materials, 2016 Scrivener Publishing LLC.).

At present, the methods for preparing a continuous fiber-reinforced ceramic matrix composite mainly include: (1) gas phase method, mainly referring to the chemical vapor infiltration method (CVI); (2) liquid phase method, mainly including the polymer infiltration and pyrolysis method (PIP) and the sol-gel method; (3) solid phase method, i.e. the hot press sintering method (HPS). Among them, the chemical vapor infiltration technique uses a gas phase precursor to be high-temperature pyrolyzed and deposited on the surface of a fiber to obtain a ceramic matrix composite. Although the fiber in the composite prepared by this method is less damaged, the method has slow deposition speed, long manufacturing period (usually taking several months to obtain a final composite) and high preparation cost, and the prepared composite has a high porosity (about 15%) (R. Naslain, F. Langlais, R. Fedou, The CVI processing of ceramic matrix composites, Journal of Physique Colloques, 1989, 50(C5): 191-207.). In the liquid phase method, the polymer infiltration and pyrolysis method or the sol-gel method uses a precursor or a sol to be immersed into a fiber preform and to generate a ceramic matrix through the high temperature pyrolysis ceramization, thereby obtaining a ceramic composite. Although this method has low heat treatment temperature, the yield of the ceramic is low. The method generally requires multiple immersions, thereby taking weeks for manufacturing, and the composite obtained also inevitably contains about 10% porosity (G. Motz, S. Schmidt, S. Beyer, The PIP process: precursor properties and applications, in Ceramic Matrix Composites: Fiber Reinforced Ceramics and their Applications, 2008 Wiley-VCH Verlag GmbH&Co.KGaA.4. E. Rodeghiero, B. Moore, B. Wolkenberg, M. Wuthenow, O. Tse, E. Giannelis, Sol-gel synthesis of ceramic matrix composites, Materials Science and Engineering: A, 1998, 244(1): 11-21.). In the hot press sintering method, a fiber is firstly immersed into a slurry containing a matrix powder, and then the fiber immersed with the slurry is made into a weftless cloth, which is subjected to a hot press sintering after lamination to obtain a composite. Although this method is easy to operate, the fiber will be severely damaged under both high temperature and high pressure, thereby greatly weakening the toughening effect of the fiber (K. Keller, G. Jefferson, R. Kerans, Oxide-Oxide composites, In: Handbook of Ceramic Composites. 2005 Springer.).

### SUMMARY

An object of the present disclosure is to provide a method for preparing a continuous fiber-reinforced ceramic matrix composite by flash sintering technology, which is used to solve the technical problems of high preparation temperature, long manufacturing period and complicated preparation process of the existing continuous fiber-reinforced ceramic matrix composite.

The object of the present disclosure may be achieved by the following technical solutions.

A method for preparing a continuous fiber-reinforced ceramic matrix composite by flash sintering technology is provided, comprising:

1) cutting a continuous ceramic fiber preform into the size of a mold, and placing in the mold; subsequently, pouring gradually a nano-ceramic powder on the continuous ceramic fiber preform in the mold for several times with a small amount for each time, and making the nano-ceramic powder fully fill the pores inside the continuous ceramic fiber preform by mechanical oscillation; then, subjecting the loose composite obtained to press forming at a certain pressure to obtain a green body;

2) placing the green body in a flash sintering furnace, heating to a preset temperature and applying an electric field with a preset electric field intensity, until occurrence of flash sintering; and

3) converting a power supply from a constant voltage state to a constant current state after the occurrence of flash sintering, holding at the temperature for a period of time at a preset current density and cooling to obtain the continuous fiber-reinforced ceramic matrix composite.

In some embodiments, in step 1), the continuous ceramic fiber is at least one selected from the group consisting of a SiC fiber, an Al₂O₃ fiber and a ZrO₂ fiber.

In some embodiments, in step 1), the continuous ceramic fiber preform comprises structurally one or more of a two-dimensional fiber cloth laminated preform, a three-dimensional needled preform and a 2.5-dimensional woven preform, and a volume fraction of the continuous ceramic fiber preform in the mold is in a range of 30-40%. The continuous ceramic fiber preform is woven with fibers, having a large number of pores thereamong, and a volume fraction of the fibers in the continuous ceramic fiber preform is in a range of 30-40%. In step 1), the continuous ceramic fiber preform is cut into the size of the mold, and then the nano-ceramic powder added fill the pores among the fibers.

In some embodiments, in step 1), the nano-ceramic powder is at least one selected from the group consisting of a SiC powder, an Al₂O₃ powder and a ZrO₂ powder, and the nano-ceramic powder has a particle size of 50-500 nm.

In some embodiments, in step 1), the mechanical oscillation is performed for 20-120 min; and

the press forming is performed at a forming pressure of 100-300 MPa for 60-600 s.

In some embodiments, in step 2), the green body has an elongated shape or a cylindrical shape, and a length of the green body in a direction of the electric field is in a range of 1-30 cm.

In some embodiments, in step 2), the heating is performed at a rate of 2-20° C./min, the preset temperature is in a range of 0.3Tₘ-0.8Tₘ, where Tₘ is a melting temperature of the nano-ceramic powder, and a temperature-holding state begins after the preset temperature is reached.

In some embodiments, in step 2), the preset electric field intensity is in a range of 20-1000 V/cm.

In some embodiments, in step 3), in the constant current state, a current density is in a range of 10-500 mA/mm².

In some embodiments, in step 3), the cooling is performed by: cooling to room temperature at a cooling rate of 5-30° C./min.

Compared with the prior art, the present disclosure applies the flash sintering technology to preparation of the continuous fiber-reinforced ceramic matrix composite, by which only a few hours are taken to obtain the ceramic matrix composite. Compared with traditional preparation methods, the preparation of the ceramic matrix composite by the flash sintering technology requires very simple equipment and a lower sintering temperature, and greatly shortens the manufacturing period. The obtained composite is more compact, having smaller ceramic grains and more excellent mechanical property.

### BRIEF DESCRIPTION OF THE DRAWINGS

FIG. 1 shows a scanning electron micrograph of the SiC fiber/SiC ceramic composite prepared in Example 1.

### DETAILED DESCRIPTION OF THE EMBODIMENTS

The present disclosure will be illustrated in detail below with reference to the drawings and embodiments.

A method for preparing a continuous fiber-reinforced ceramic matrix composite by flash sintering technology is provided, which comprises the following steps:

1) A two-dimensional fiber cloth laminated, a three-dimensional needled or a 2.5-dimensional woven SiC fiber, Al₂O₃ fiber or ZrO₂ fiber is used as a continuous ceramic fiber preform, which is cut into the size of a mold and placed in the mold, wherein the mold has an elongated or cylindrical shape and a length of 1-30 cm, and a volume fraction of the fiber is in a range of 30-40%. Subsequently, SiC nano-ceramic powders, Al₂O₃ nano-ceramic powders or ZrO₂ nano-ceramic powders with a particle size of 50-500 nm are gradually poured on the continuous ceramic fiber preform in the mold for several times with a small amount for each time. The nano-ceramic powders are made to fully fill the pores inside the continuous ceramic fiber preform by mechanical oscillation for 20-120 min, to obtain a loose composite.

2) The loose composite is pressed at a forming pressure of 100-300 MPa for 60-600 s, to obtain a green body.

3) The green body is placed in a flash sintering furnace, heated to a preset temperature of 0.3Tₘ-0.8Tₘ at a heating rate of 2-20° C./min (Tₘ is the melting temperature of the nano-ceramic powder), and held at the temperature for 20-120 min.

4) An electric field with a preset electric field intensity (20-1000 V/cm) is applied to both ends of the green body in the length direction, until the occurrence of flash sintering. Thereafter, the power supply is converted from a constant voltage state to a constant current state. The resultant is held at the temperature for 1-30 min at a preset current density (10-500 mA/mm²), and cooled to room temperature at a cooling rate of 5-30° C./min, to obtain the continuous fiber-reinforced ceramic matrix composite.

The following examples are carried out on the premise of the technical solutions of the present disclosure, illustrating the detailed embodiments and specific operation processes. However, the protection scope of the present disclosure will not be limited to the following examples.

### Example 1

A method for preparing a continuous fiber-reinforced ceramic matrix composite by flash sintering technology was performed by the following steps:

1) A three-dimensional needled SiC fiber preform was placed into a 2 cm×10 cm×2 cm elongated mold in a volume fraction of 40% of the mold size. Subsequently, SiC powders with a particle size of 300 nm were poured on the SiC fiber preform in the mold for 5 times. The SiC powders were made to fully fill the pores inside the SiC fiber preform by mechanical oscillation for 30 min, obtaining a loose composite.

2) The loose composite was pressed at a forming pressure of 200 MPa for 120 s, obtaining a green body.

3) The green body was placed in a flash sintering furnace, heated to a preset temperature of 1300° C. at a heating rate of 5° C./min, and held at the temperature for 30 min.

4) An electric field with a preset electric field intensity of 100 V/cm was applied to both ends of the green body in the length direction, until the occurrence of flash sintering. Thereafter, the power supply was converted from a constant voltage state to a constant current state. The resultant was held at the temperature for 10 min at a preset current density of 200 mA/mm², and cooled to room temperature at a cooling rate of 5° C./min, obtaining a SiC fiber/SiC ceramic composite.

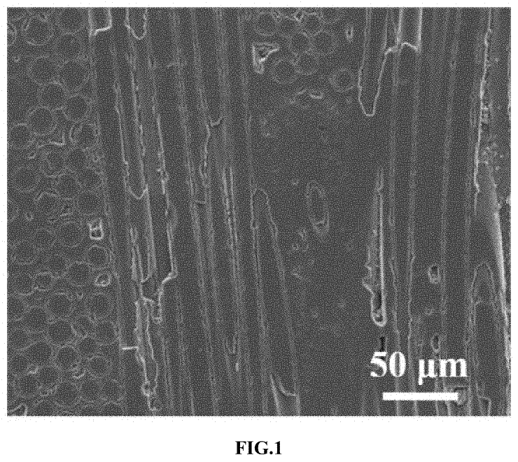

The scanning electron micrograph of the SiC fiber/SiC ceramic composite prepared in this example is shown in FIG. 1. It can be seen from the FIGURE that the obtained composite has uniformly distributed matrix and compactness up to 97%, and the fiber has a desirable bonding with the interface. The tensile intensity of the obtained composite may reach up to 280 MPa, higher than the intensity (about 200 MPa) of the SiC fiber/SiC composite prepared by the conventional PIP method.

### Example 2

A method for preparing a continuous fiber-reinforced ceramic matrix composite by flash sintering technology was performed by the following steps:

1) A two-dimensional fiber cloth laminated SiC fiber preform was placed into a 4 cm×10 cm×2 cm elongated mold in a volume fraction of 30% of the mold size. Subsequently, SiC powders with a particle size of 200 nm were poured on the SiC fiber preform in the mold for 8 times. The SiC powders were made to fully fill the pores inside the SiC fiber preform by mechanical oscillation for 120 min, obtaining a loose composite.

2) The loose composite was pressed at a forming pressure of 200 MPa for 240 s, obtaining a green body.

3) The green body was placed in a flash sintering furnace, heated to a preset temperature of 1250° C. at a heating rate of 10° C./min, and held at the temperature for 30 min.

4) An electric field with a preset electric field intensity of 200 V/cm was applied to both ends of the green body in the length direction, until the occurrence of flash sintering. Thereafter, the power supply was converted from a constant voltage state to a constant current state. The resultant was held at the temperature for 10 min at a preset current density of 300 mA/mm², and cooled to room temperature at a cooling rate of 10° C./min, obtaining a SiC fiber/SiC ceramic composite. The tensile intensity of the obtained composite may reach up to 248 MPa, higher than the intensity (about 200 MPa) of the SiC fiber/SiC composite prepared by the conventional PIP method.

### Example 3

A method for preparing a continuous fiber-reinforced ceramic matrix composite by using flash sintering technology was performed by the following steps:

1) A 2.5-dimensional SiC fiber preform was placed into a 2 cm×10 cm×5 cm elongated mold in a volume fraction of 35% of the mold size. Subsequently, SiC powders with a particle size of 150 nm were poured on the SiC fiber preform in the mold for several times with a small amount for each time. The SiC powders were made to fully fill the pores inside the SiC fiber preform by mechanical oscillation for 60 min, obtaining a loose composite.

2) The loose composite was pressed at a forming pressure of 300 MPa for 300 s, obtaining a green body.

3) The green body was placed in a flash sintering furnace, heated to a preset temperature of 1300° C. at a heating rate of 2° C./min, and held at the temperature for 20 min.

4) An electric field with a preset electric field intensity of 500 V/cm was applied to both ends of the green body in the length direction, until the occurrence of flash sintering. Thereafter, the power supply was converted from a constant voltage state to a constant current state. The resultant was held at the temperature for 15 min at a preset current density of 200 mA/mm², and cooled to room temperature at a cooling rate of 10° C./min, obtaining a SiC fiber/SiC ceramic composite. The tensile intensity of the obtained composite may reach up to 265 MPa, higher than the intensity (about 200 MPa) of the SiC fiber/SiC composite prepared by the conventional PIP method.

### Example 4

A method for preparing a continuous fiber-reinforced ceramic matrix composite by using flash sintering technology was performed by the following steps:

1) A two-dimensional fiber cloth laminated Al₂O₃ fiber preform was placed into a φ 3 cm×10 cm cylindrical mold in a volume fraction of 30% of the mold size. Subsequently, Al₂O₃ powders with a particle size of 250 nm were poured on the Al₂O₃ fiber preform in the mold for 10 times. The Al₂O₃ powders were made to fully fill the pores inside the Al₂O₃ fiber preform by mechanical oscillation for 60 min, obtaining a loose composite.

2) The loose composite was pressed at a forming pressure of 150 MPa for 300 s, obtaining a green body.

3) The green body was placed in a flash sintering furnace, heated to a preset temperature of 1100° C. at a heating rate of 10° C./min, and held at the temperature for 60 min.

4) An electric field with a preset electric field intensity of 1000 V/cm was applied to both ends of the green body in the length direction, until the occurrence of flash sintering. Thereafter, the power supply was converted from a constant voltage state to a constant current state. The resultant was held at the temperature for 10 min at a preset current density of 50 mA/mm², and cooled to room temperature at a cooling rate of 10° C./min, obtaining an Al₂O₃ fiber/Al₂O₃ ceramic composite. The tensile intensity of the obtained composite may reach up to 239 MPa.

### Example 5

A method for preparing a continuous fiber-reinforced ceramic matrix composite by using flash sintering technology was performed by the following steps:

1) A two-dimensional fiber cloth laminated ZrO₂ fiber preform was placed into a φ 5 cm×5 cm cylindrical mold in a volume fraction of 30% of the mold size. Subsequently, ZrO₂ powders with a particle size of 500 nm were poured on the ZrO₂ fiber preform in the mold for 6 times. The ZrO₂ powders were made to fully fill the pores inside the ZrO₂ fiber preform by mechanical oscillation for 120 min, obtaining a loose composite.

2) The loose composite was pressed at a forming pressure of 250 MPa for 600 s, obtaining a green body.

3) The green body was placed in a flash sintering furnace, heated to a preset temperature of 950° C. at a heating rate of 10° C./min, and held at the temperature for 30 min.

4) An electric field with a preset electric field intensity of 1000 V/cm was applied to both ends of the green body in the length direction, until the occurrence of flash sintering. Thereafter, the power supply was converted from a constant voltage state to a constant current state. The resultant was held at the temperature for 15 min at a preset current density of 50 mA/mm², and cooled to room temperature at a cooling rate of 15° C./min, obtaining a ZrO₂ fiber/ZrO₂ ceramic composite. The tensile intensity of the obtained composite may reach up to 233 MPa.

The embodiments described above are intended to facilitate those of ordinary skill in the art to understand and use the present disclosure. Obviously, those skilled in the art could easily make various modifications to these embodiments and apply the general principles as demonstrated here to other embodiments without creative work. Therefore, the present disclosure is not limited to the above embodiments. The improvements and modifications made by those skilled in the art based on the revelation of the present disclosure without departing from the scope of the present disclosure should fall within the protection scope of the present disclosure.

What is claimed is:

1. A method for preparing a continuous fiber-reinforced ceramic matrix composite by flash sintering technology, comprising:
1) placing a continuous ceramic fiber preform in a mold, adding a nano-ceramic powder, and subjecting the resultant to mechanical oscillation and press forming in sequence to obtain a green body;
2) heating the green body to a preset temperature and applying an electric field with a preset electric field intensity, until occurrence of flash sintering; and
3) converting a power supply from a constant voltage state to a constant current state, holding at the temperature and cooling to obtain the continuous fiber-reinforced ceramic matrix composite.

2. The method of claim 1, wherein in step 1), the continuous ceramic fiber is at least one selected from the group consisting of a SiC fiber, an Al₂O₃ fiber and a ZrO₂ fiber.

3. The method of claim 1, wherein in step 1), the continuous ceramic fiber preform comprises structurally one or more of a two-dimensional fiber cloth laminated preform, a three-dimensional needled preform and a 2.5-dimensional woven preform, and a volume fraction of the continuous ceramic fiber preform is in a range of 30-40%.

4. The method of claim 1, wherein in step 1), the nano-ceramic powder is at least one selected from the group consisting of a SiC powder, an Al₂O₃ powder and a ZrO₂ powder, and the nano-ceramic powder has a particle size of 50-500 nm.

5. The method of claim 1, wherein in step 1), the mechanical oscillation is performed for 20-120 min; and
the press forming is performed at a forming pressure of 100-300 MPa for 60-600 s.

6. The method of claim 1, wherein in step 2), the green body has an elongated shape or a cylindrical shape, and a length of the green body in a direction of the electric field is in a range of 1-30 cm.

7. The method of claim 1, wherein in step 2), the heating is performed at a rate of 2-20° C./min, and the preset temperature is in a range of 0.3Tₘ-0.8Tₘ, wherein Tₘ is a melting temperature of the nano-ceramic powder.

8. The method of claim 1, wherein in step 2), the preset electric field intensity is in a range of 20-1000 V/cm.

9. The method of claim 1, wherein in step 3), in the constant current state, a current density is in a range of 10-500 mA/mm².

10. The method of claim 1, wherein in step 3), the cooling comprises cooling to room temperature at a cooling rate of 5-30° C./min.
